(19) United States
(12) Patent Application Publication
(10) Pub. No.: US 2008/0129474 A1
(43) Pub. Date: Jun. 5, 2008

(54) Collision sensor system

(76) Inventor: Dimitrie Marandiuc, Chicago, IL (US)

Correspondence Address: Dimitrie Marandiuc, 5320 West Berenice Avenue, Chicago, IL, 60641, US

(21) Appl. No.: 11/983,919

(22) Filed: Nov. 13, 2007

Related U.S. Application Data
(60) Provisional application No. 60/860,892, filed on Nov. 24, 2006.

(51) Int. Cl. G08B 21/00

(52) U.S. Cl. 340/436

(57) ABSTRACT

A collision sensor for a vehicle includes a base, a spring, and a rod. The base is used for attaching the collision sensor to the vehicle. The spring is attached to the base and has a hollow interior area. The rod is coupled to an electrical source and is located in the hollow interior area of the spring. The rod is electrically insulated from the spring when the collision sensor is in an initial position, to stop electrical flow to an alarm generator. The rod is in electrical contact with the spring when the collision sensor is in a bent position, to allow electrical flow to the alarm generator.

### RELATED APPLICATIONS

This application is related to and claims priority to U.S. Provisional Patent Application Ser. No. 60/860,892 filed Nov. 24, 2006, titled “Collision Sensor System,” which is incorporated herein in its entirety.

### FIELD OF THE INVENTION

The present invention relates generally to collision sensors and, in particular, to a collision sensor for a vehicle that generates an alarm when the collision sensor is physically deformed.

### BACKGROUND OF THE INVENTION

A person operating a vehicle is required to perform various maneuvers based on obstacles located on the terrain on which the vehicle is being operated. For example, a driver of a semi-trailer truck must occasionally maneuver around other cars, buildings, poles, narrow alleys, etc. Often, such as when moving the truck backwards for loading or unloading purposes, the driver must rely solely on mirrors for avoiding any potential obstacles.

One problem with the mirrors is that they provide a limited view of the obstacles and/or the desired driving path. Although a solution for the driver is to rely on a second person for communicating the proximity of the truck to the particular obstacles and for directing the driver, the second person is most often unavailable. Thus, the driver is forced to rely solely on his or her limited visual field, which is likely to result in high damage especially to the lateral sides of the truck.

Even if the second person is available to direct the driver, the communication between the driver and the second person is not always clear and/or precise. For example, if the driver is required to drive the truck backwards in a tight alley, the second person may not have clear access to properly direct the driver. Miscommunication or lack of communication potentially increases the likelihood that the driver will fail to avoid the obstacles and, consequently, potentially cause physical damage to the driver, the second person, other persons, the truck, and/or other property.

Thus, a need exists for a sensing device that can make a vehicle operator aware of a potential obstacle. The present invention is directed to satisfying one or more of these needs and to solving other problems.

### SUMMARY OF THE INVENTION

According to one aspect of the present invention, a collision sensor for a vehicle includes a base, a spring, and a rod. The base is used for attaching the collision sensor to the vehicle. The spring is attached to the base and has a hollow interior area. The rod is coupled to an electrical source and is located in the hollow interior area of the spring. The rod is electrically insulated from the spring when the collision sensor is in an initial position, to stop electrical flow to an alarm generator. The rod is in electrical contact with the spring when the collision sensor is in a bent position, to allow electrical flow to the alarm generator.

According to another aspect of the invention, a method for manufacturing a collision sensor for use in a vehicle includes providing a base for attaching the collision sensor to the vehicle. A spring is attached to the base, the spring having a hollow interior space. A rod is located at least partially inside the hollow interior space of the spring. The rod is electrically insulated from the spring when the collision sensor is in a default position to have an open electrical path between an electrical source and an alarm generator. In response to the rod being in contact with the spring when the collision sensor is in a deformed position, the electrical path produces an alarm.

According to yet another aspect of the invention, a collision sensor for a truck includes a metallic base, an extension metallic spring, a tubular electrical insulator, and an elastic metallic wire. The metallic base is used for attaching the collision sensor to a cabin of the truck. The extension metallic spring has a central axis, a first spring end, and a second spring end, the first spring end being attached to the base. The tubular electrical insulator has a central aperture, the electrical insulator being located at least in part inside the metallic spring near the first spring end. The elastic metallic wire has a first wire end and a second wire end, the first wire end being coupled to an electrical source and located inside the central aperture of the electrical insulator. The second wire end being separated by a gap from the second spring end when the collision sensor is in an initial position to open a electrical path including a sound generator. The second wire end is in contact with the second spring end when the collision sensor is in a bent position to close the electrical path.

The above summary of the present invention is not intended to represent each embodiment or every aspect of the present invention. The detailed description and Figures will describe many of the embodiments and aspects of the present invention.

### BRIEF DESCRIPTION OF THE DRAWINGS

The foregoing and other advantages of the invention will become apparent upon reading the following detailed description and upon reference to the drawings.

FIG. 1 illustrates a partial cross-sectional side view of a collision sensor, according to one embodiment of the present invention.

FIG. 2 illustrates the collision sensor in an alarm-generating position.

FIG. 3 illustrates an electrical path for the collision sensor.

FIG. 4A illustrates a side view of a truck vehicle on which the collision sensor is mounted, according to an alternative embodiment of the present invention.

FIG. 4B illustrates a top view of the truck vehicle of FIG. 4A.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

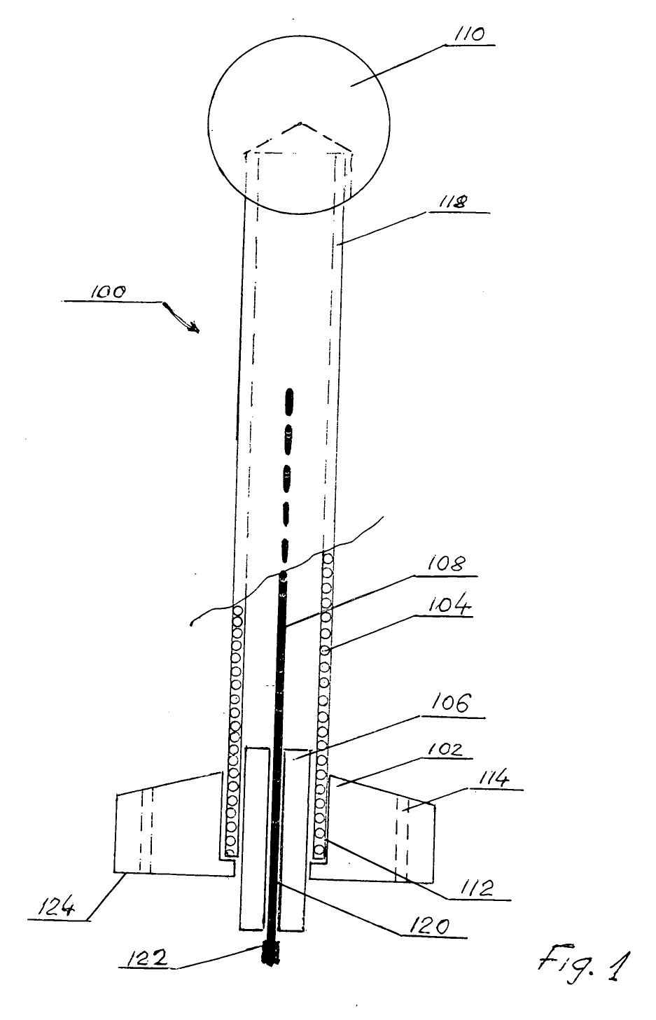

Referring to FIG. 1, a collision sensor 100 for detecting vehicle obstacles is shown in an initial undeformed position (or shape) and includes a base 102, a spring 104, an insulator 106, an internal rod 108, and a contact member 110. The base 102 includes a base central hole 112 and a plurality of attachment holes 114 that are located away from the base central hole 112, near an edge of the base 102. The attachment holes 114 are used for securing the base 102 to a vehicle, as described in more detail below. The base 102 is made from an electrically conductive material, e.g., a metal such as steel, stainless steel, and aluminum. The base 102 is attached to a vehicle, such as a truck cabin, using any one or more of a number of fasteners, including screws, bolts, welding, etc.

The base 102 can have any shape (e.g., square, rectangular, etc.) and/or can include other structural members. For example, the base 102 can include a rectangular plate that is attached on a surface of the base 102 away from the spring 104. The rectangular plate of the base 102 can be used to provide strength and stability to the collision sensor 100 when attached to the vehicle. Additionally, the rectangular plate of the base 102 can be used for providing a particular hole pattern that may be better suited for attaching the base 102 to the vehicle.

The spring 104 is a steel extension spring having a central axis along the length of the spring, a fixed end 116, and a movable end 118. The fixed end 116 is secured to the base 102 by inserting the fixed end 116 into the base 102. When the spring 104 is secured to the base 102, the central axis of the spring 104 is coaligned with a central axis of the base central hole 112.

The movable end 118 of the spring 104 is free to move when a deforming force acts on it, e.g., when the collision sensor 100 hits an obstacle. When the deforming force acts on the movable end 118, the spring 104 changes from an initial undeformed shape to one of a plurality of deformed spring shapes. When the deforming force is removed, the spring 104 returns to its initial undeformed shape.

The insulator 106 is cylindrically shaped and includes an insulator central hole 120. The insulator 106 is secured to the fixed end 116 of the spring 104 by inserting the insulator 106 into the spring 104. The insulator central hole 120 is coaligned with the base central hole 112. The insulator 106 is made from an electrically non-conductive material, such as plastic, cork, ceramic, etc.

The internal rod 108 is an electrically conductive (e.g., metallic) wire having an electrically coupled end 122 and a sensor end 124. The internal rod 108 is inserted into the spring 104, along the central axis of the spring 104, and has the electrically coupled end 122 protruding from the base 102 towards the vehicle. The internal rod 108 is secured to the collision sensor 100 via the insulator 106 by inserting the electrically coupled end 122 through the insulator central hole 120. The electrically coupled end 122 is coupled via an electrical connection to an electrical power source.

The sensor end 124 is positioned along the central axis of the spring 104 when the collision sensor 100 is in its initial undeformed position. Thus, in the undeformed position, the sensor end 124 does not make electrical contact with the spring 104. When the spring 104 is deformed, the sensor end 124 makes physical and, consequently, electrical contact with the spring 104.

The internal rod 108 has elastic or superelastic properties. Specifically, the elastic properties of the internal rod 108 permits the internal rod 108 to return to its original undeformed shape after being deformed by the deforming force, such as when the vehicle moves away from an obstacle after the vehicle has made physical contact with the obstacle. For example, the internal rod 108 can be a NiTi (nickel titanium) wire alloy N, having a diameter of one millimeter (0.0394 inches), and being straight annealed with its surface pickled.

The contact member 110 can a spherical ball that is coupled to the movable end 118 of the spring 104. The contact member 110 is the component of the collision sensor 100 that is located farthest away from the vehicle and it is the most likely component to make contact with the obstacle. The contact member 110 can be made from any material and can have any shape. Preferably, the contact member 110 is made from a contact-resistant material such that contacts with obstacles will have minimum effect on the shape and/or size of the contact member 110. For example, the contact member 110 can be made from a plastic or a wood material.

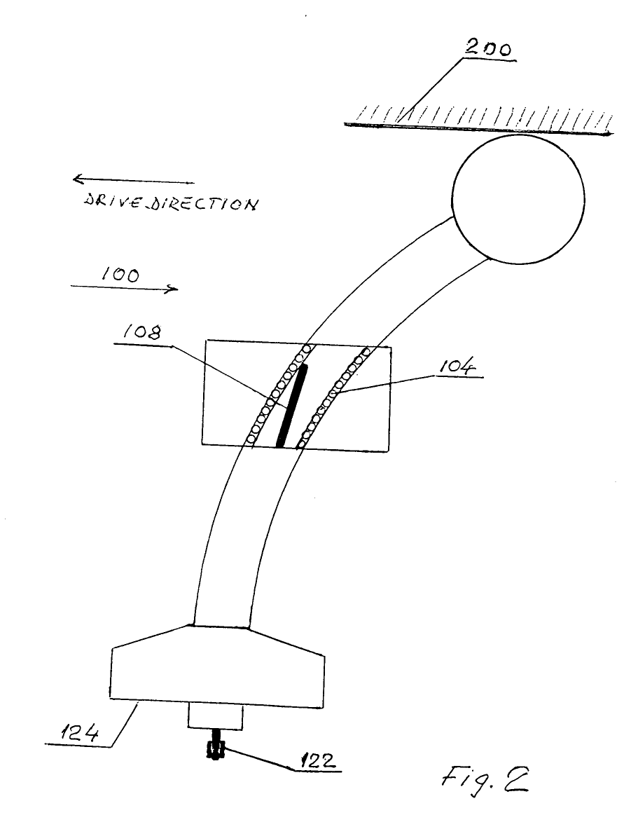

Referring to FIG. 2, the collision sensor 100 is shown in a deformed position that is caused by the vehicle making contact with (or hitting) an obstacle 200. As the vehicle is driven in the direction of the “Drive Direction” arrow, the collision sensor 100 makes contact with the obstacle 200. The obstacle 200 exerts a force opposite to the “Drive Direction” of the vehicle and causes the collision sensor 100 to bend in the deformed position. Consequently, the internal rod 108, which initially is not in contact with the spring 104, makes physical contact with the wall of the spring 104. As explained in more detail below, the physical contact between the internal rod 108 and the spring 104 causes an alarm to sound to alert the vehicle driver that the vehicle is about to make impact with the obstacle 200.

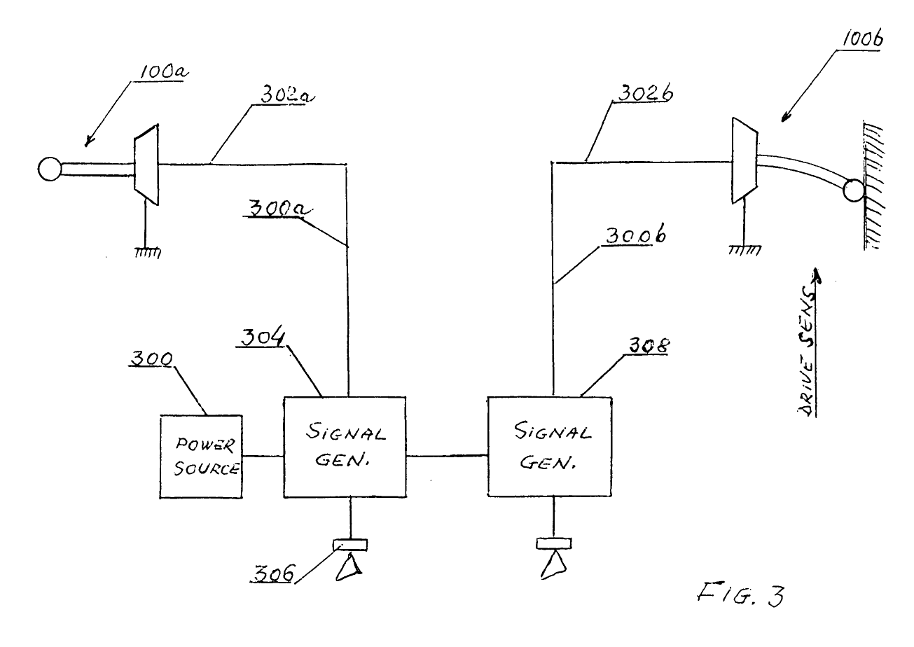

Referring to FIG. 3, an electrical diagram shows the coupling of two independent collision sensors 100a, 100b to an electrical power source 300. While the discussion below refers only to one of the collision sensors 100a, 100b, it is understood that discussion applies to both collision sensors 100a, 100b. Further the use of two collision sensors 100a, 100b is optional (e.g., the driver can use one or more collision sensors).

The collision sensor 100a is electrically coupled via an electrical wire 302a to a sound generator 304. For example, the electrically coupled end 122 of the internal rod 108 is electrically connected directly to the electrical wire 302. The sound generator 304 is electrically coupled to the electrical power source 300 and to a sound generator 304 and a sound device 306. The collision sensor 100b, if used, may be electrically coupled to the sound generator 308 via its own electrical wire 302b.

Thus, an electrical path is formed between the electrical power source 300a, the sound generator 304, the sound device 306, and the collision sensor 100a. In response to the electrical contact formed between the internal rod 108 and the spring 104, the electrical path can change between an open electrical path and a closed electrical path. When the collision sensor 100a is in the undeformed position (i.e., the internal rod 108 is not in electrical contact with the spring 104), the electrical path is open. When the collision sensor 100a is in the deformed position (i.e., the internal rod 108 is in electrical contact with the spring 104), the electrical path is closed and the sound device 306 produces an alert sound for the driver.

According to an alternative embodiment, one or more of the collision sensors 100a, 100b are wirelessly coupled to the sound generator 304. For example, the collision sensor 100a includes a self-contained power source (e.g., a battery) and a signal transmitter that wirelessly transmits an activating signal to the sound generator 304. When the collision sensor 100a is in the deformed position, the activating signal is transmitted and received by a signal receiver of the sound generator 304. Consequently, the sound generator 304 produces the alert sound for the driver.

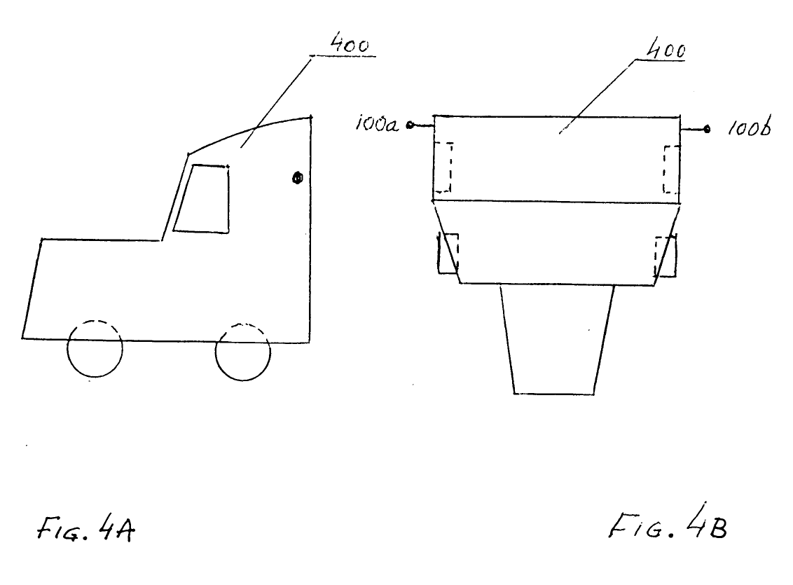

Referring to FIG. 4, the collision sensors 100a, 100b are attached to a truck cabin 400. The collision sensors 100a, 100b can be attached anywhere on the exterior of the truck cabin. Preferably, the collision sensors 100a, 100b are attached near particular blind spots of the driver, e.g., behind the driver, at a height generally equal to the driver's head level.

According to one embodiment of the present invention, the electrical power source 300a can be provided by a cigarette lighter of the truck cabin 400. For example, the collision sensor 100a is attached to the exterior of the truck cabin 400 and is connected via an electrical wire to the cigarette lighter of the truck cabin 400.

Optionally, the sound device 306 can be integrated with the sound generator 304 or it can be a sound device of the truck cabin 400. For example, the sound generator 304 can be coupled to a horn of the truck cabin 400 such that when a collision is detected by the collision sensor 100, the horn emits a loud sound.

According to alternative embodiments of the present invention, the collision sensor 100 is coupled to a visual alarm generator, in addition or instead of the sound generator 306. For example, the visual alarm generator can cause a light to blink in the truck cabin 400 to alert the driver that an obstacle has been hit.

While the present invention has been described with reference to one or more particular embodiments, those skilled in the art will recognize that many changes may be made thereto without departing from the spirit and scope of the present invention. For example, while the above examples refer generally to a truck vehicle, such as a tractor trailer, the collision sensor can be used on any type of vehicle, including passenger cars, motorcycles, boats, and airplanes. Each of these embodiments and obvious variations thereof is contemplated as falling within the spirit and scope of the claimed invention, which is set forth in the following claims.

What is claimed is:

1. A collision sensor for a vehicle comprising:
a base for attaching the collision sensor to the vehicle;
a spring attached to the base and having a hollow interior area; and
a rod coupled to an electrical source and located in the hollow interior area of the spring, the rod being electrically insulated from the spring when the collision sensor is in an initial position to stop electrical flow to an alarm generator, the rod being in electrical contact with the spring when the collision sensor is in a bent position to allow electrical flow to the alarm generator.

2. The collision sensor of claim 1, wherein the base is a metallic material.

3. The collision sensor of claim 1, wherein the spring is a stainless steel extension spring.

4. The collision sensor of claim 1, wherein the rod is a wire including at least one of an elastic metal or a superelastic metal.

5. The collision sensor of claim 1, further comprising a contact member attached to an end of the spring, the contact member being in contact with an obstacle in the bent position of the collision sensor.

6. The collision sensor of claim 1, further comprising an electrical insulator located at least partially inside the hollow interior area of the spring for supporting the rod, the electrical insulator having an aperture for receiving an end of the rod, the electrical insulator electrically insulating the end of the rod in the initial position and the bent position of the collision sensor.

7. The collision sensor of claim 1, wherein the rod is located along an axis of the spring and having a first end and a second end, the first end being permanently separated from contacting the spring via a tubular insulator, the second end being separated from the spring by a gap when the collision sensor is in the initial position, the second end being in contact with the spring when the collision sensor is in the bent position.

8. The collision sensor of claim 1, further comprising a cable for coupling the rod to the electrical source, the electrical source being a cigarette lighter of the vehicle.

9. The collision sensor of claim 1, wherein the alarm generator produces an alarm selected from a group consisting of an audio alarm and a visual alarm.

10. A method for manufacturing a collision sensor for use in a vehicle, the method comprising:
providing a base for attaching the collision sensor to the vehicle;
attaching a spring to the base, the spring having a hollow interior space;
locating a rod at least partially inside the hollow interior space of the spring;
electrically insulating the rod from the spring when the collision sensor is in a default position to have an open electrical path between an electrical source and an alarm generator; and
in response to the rod being in contact with the spring when the collision sensor is in a deformed position, closing the electrical path to produce an alarm.

11. The method of claim 10, wherein the spring is partially inserted in the base.

12. The method of claim 10, wherein the rod is locates along a central axis of the spring.

13. The method of claim 10, further comprising attaching a contact ball at one end of the spring for contacting an obstacle when the collision sensor is in the deformed position, the end of the spring being opposite another end of the spring that is attached to the base.

14. The method of claim 10, wherein the rod is a wire selected from a group consisting of an elastic metal and a superelastic metal, the rod having the ability to change between a distorted shape and an undistorted shape when the collision sensor changes between the deformed position and the default position.

15. The method of claim 10, further comprising locating a tubular insulator between the rod and the spring at one end of the spring for supporting the rod, the tubular insulator having an aperture for receiving the rod.

16. The method of claim 10, wherein the alarm includes an audio sound for alerting a driver of the vehicle that the collision sensor has collided with the obstacle.

17. The method of claim 10, wherein the alarm includes a visual message for alerting a driver of the vehicle that the collision sensor has collided with the obstacle.

18. The method of claim 10, further comprising transmitting a wireless signal for activating the alarm.

19. A collision sensor for a truck comprising:
a metallic base for attaching the collision sensor to a cabin of the truck;
an extension metallic spring having a central axis, a first spring end, and a second spring end, the first spring end being attached to the base;
a tubular electrical insulator having a central aperture, the electrical insulator being located at least in part inside the metallic spring near the first spring end; and
an elastic metallic wire having a first wire end and a second wire end, the first wire end being coupled to an electrical source and located inside the central aperture of the electrical insulator, the second wire end being separated by a gap from the second spring end when the collision sensor is in an initial position to open a electrical path including a sound generator, the second wire end being in contact with the second spring end when the collision sensor is in a bent position to close the electrical path.

20. The collision sensor of claim 19, wherein the electrical source is selected from a group consisting of a cigarette lighter of the truck and a self-contained battery of the collision sensor.
